(19) United States
(12) Patent Application Publication
(10) Pub. No.: US 2003/0049986 A1
(43) Pub. Date: Mar. 13, 2003

(54) Protective woven fabric with crease retention

(76) Inventors: Naseer Mohammad Qureshi, Toronto (CA); William Barnes, Sarasota, FL (US)

Correspondence Address: ROBERTS ABOKHAIR & MARDULA, SUITE 1000, 11800 SUNRISE VALLEY DRIVE, RESTON, VA, 20191, US

(21) Appl. No.: 10/116,665

(22) Filed: Apr. 4, 2002

Related U.S. Application Data
(60) Provisional application No. 60/317,576, filed on Sep. 6, 2001.

(51) Int. Cl. B32B 5/18; D03D 15/00; B32B 5/24

(52) U.S. Cl. 442/221; 442/290; 428/318.6

(57) ABSTRACT

The present invention provides recyclable protective wraps with crease retention useful in protecting metal objects from atmospheric corrosion and moisture. The protective wraps comprise an outer barrier layer, a flexible woven substrate and an inner barrier layer. All layers are preferably of polypropylene. The outer barrier layer may further comprise ultraviolet light inhibitors. The woven substrate is preferably a tight weave. The inner barrier layer may further comprise vapor phase corrosion inhibitors. When so present, the VCIs containing inner barrier layer is identified with by the addition of a pigment of different color or shade than that of the outer barrier layer.

### CROSS REFERENCE TO RELATED APPLICATIONS

This application claims priority from pending U.S. provisional patent application serial No. 60/317,576, filed Sep. 6, 2001.

### BACKGROUND OF THE INVENTION

Protective fabrics are used for such applications as steel coil wrap, steel sheeting, pallet shrouds, equipment covers and many other protective applications. When used as steel coil wrap or metal parts wrap the protective fabrics protect the otherwise metal exposed area from corrosion, including moisture induced oxidation. Preferably such metal wraps comprise recyclable materials that reduce or eliminate landfill disposal expenses.

Protective fabrics are utilized due to their abrasion protective ability, high strength, good puncture resistance, light weight, flexibility and ease of use. In order to be easily recyclable yet produced at economic prices, protective fabrics are often formed of thermoplastic polymer fibers such as those from polyethylene.

The corrosion of metallic parts and raw materials is a problem that is encountered by manufacturers, transportation companies, retailers and the consuming public alike. Unchecked corrosion can lead to a reduction in value or a diminishing of the lifespan for metallic items. While corrosion may come in many forms and may be the result of many different causes, it is the corrosion that results from the ambient environment within which a part or metallic item is stored or transported to which this invention is directed.

The most common metals that are susceptible to corrosion from ambient or atmospheric conditions are iron or ferrous compounds, aluminum, brass, copper, and lead. The corrosion of such metals, and metallic items created from them, may take the form of oxidation, tarnishing, pitting, discoloration or the mottling of the exterior surface. Traditionally, corrosion of this nature is associated with contact between the metallic surface and liquids, such as water or acidic compounds. However, in many instances the corrosion may be a direct result of the ambient atmospheric conditions within which the metallic item is situated.

For example, metallic parts, machinery and raw materials are often exposed to gaseous compounds of oxygen, water vapor, carbon dioxide, nitrogen dioxide, sulfur dioxide and other such gases that can create an inherently corrosive environment. It is therefore desirable that steps be taken to prevent corrosion from exposure to such atmospheric elements, particularly during shipping and storage of metallic items. When such items are also subjected to sodium chloride (for example when shipped by sea or by truck in northern climates during the winter) even further precautionary steps need to be taken.

Protective fabrics are made to reduce or help eliminate corrosion during storage and transportation. As a first measure to prevent corrosion such fabrics are coated with liquid and moisture barrier materials, on at least one side of the fabric, but preferably on both sides of the fabric. In order to maintain recylcability, and obtain good adherence of the coating to the fabric, it is often preferred that the coatings comprise compositions similar to that of the underlying protective fabric.

Another approach to corrosion protection for metals is the use of vapor phase corrosion inhibitors (VCIs). In general, VCIs release gaseous compounds that help to protect the surfaces of metals through the deposition of a protective film or coating on the corrodible surface. Provided that a sufficient supply of the vapor phase corrosion inhibitor is available, a metallic item can be protected for a considerable length of time.

Compositions useful as VCIs are further described in U.S. Pat. Nos. 6,033,599; 5,855,975; 5,894,040; 5,422,187 and 5,139,700; all of which are incorporated herein by reference. VCI compounds can be incorporated into kraft paper protective wraps as described in U.S. Pat. No. 5,894,040. Kraft paper wraps have an open, porous structure that allows the VCIs to easily permeate to the site of the metal.

In order to extend the useful life of kraft paper VCI wraps, an outer plastic film layer is added to provide moisture protection and contain the VCI gaseous compounds within the confines of the protected metal package. Although this approach extends the useful life it unfortunately creates a packaging material that is not suitable for recycling. After use, these composite materials cannot be easily separated into recyclable materials, for example, cellulose fibers and thermoplastics.

Another approach for using VCIs in a protective wrap incorporates the VCI into a film wrap. Examples of this approach are presented in U.S. Pat. No. 5,855,975. Unlike the composite kraft paper/film materials, these products are more suited to recycling. However, these products must be formulated to be compatible to the VCI utilized and allow sufficient permeation of the VCI gases through the film. It is also desired that multiple layer films be used so that permeation of VCI gases can be both contained and directed to protecting the metal object being packaged.

Films also suffer from poor puncture resistance and strength limitations. Transverse direction tear and puncture resistance are particularly tough problems to solve for protecting metal parts.

Woven fabrics can provide improvements over films for increased strength and puncture resistance. When woven of thermoplastic resins, they can be readily recyclable. U.S. Pat. No. 5,863,642 is directed to woven thermoplastic wraps incorporating VCIs and is incorporated herein by reference.

Such woven fabrics may also be coated with barrier layer(s) that are useful as moisture barriers or VCI containing coatings. Moisture barriers function to protect the enclosed metal device from moisture or other air borne contaminants as well as helping contain the VCI gases and extend the useful life of their protective effects.

The woven fabrics of U.S. Pat. No. 5,863,642 are often of a medium weave. Such weaves reduce desirable appearance as well as inherent moisture protection. For this reason, such fabrics are improved by using a dense weave.

Additionally, the woven fabric composites of U.S. Pat. No. 5,863,642 have not been well accepted in the marketplace as they lack significant crease retention as compared to the kraft paper/film composite materials.

High crease retention is advantageous when using protective wraps to encompass coils of steel produced at steel rolling mills and continuous casters. Steel mills frequently manufacture sheets of steel having a length many times greater than its width. The sheets are subsequently wound into a coil or roll for compact storage and handling. Typically steel coils may be wound from sheets of varying length, and twenty to eighty inches in width, resulting in coils having a diameter between about twenty-five to eighty inches. Such coils are quite heavy, generally weighing from one to ten tons or more. FIG. 3 illustrates a typical coil. Such coils have an annular shape with an inner diameter 10, an outer diameter 11 and a width 12.

The process for protecting a steel coil is: wrapping the protective material around the perimeter of the coil, covering the front side by folding the material over the steel and into the inner space, covering the back side by folding the material over the steel and into the inner space, overlapping the fabric previously folded into this space from the front of the coil. Finally, a securing method is added to hold the protective material in place. These steps are depicted in FIG. 4a, 4b, 4c and 4d. In FIG. 4a a protective fabric 1 is wrapped around the steel coil extending over both the front and back of the coil. The steel coil has an outer diameter 11 and a width 12.

In FIG. 4b the back of the steel coil has been covered by folding the fabric 1 into the inside of the coil. Protective fabric continues to overhang the front of the steel coil. The steel coil is noted as having outer diameter 11 and width 12.

In FIG. 4c the front and back of the steel coil has been covered by folding the fabric 1 into the inside of the coil. The steel coil has an outer diameter 11 and width 12. As a result, in FIG. 4c the steel coil is completely enclosed within the protective fabric. Fabric 1 becomes creased as it is folded over the edges of the steel coil and further creased as it is bunched into the center of the steel coil.

Finally, the fabric 1 is secured to the steel coil. Some customers may also insert an inner cylindrical liner 47, for example a cylinder fashioned of a kraft material, during the final step. Similarly, customers may secure the fabric 1 with straps or banding material 48. The resultant steel coil, fully enclosed by a secured protective fabric, as illustrated in FIG. 4d.

High crease retention materials ease this process by staying in place after they are folded. When in FIG. 4b, the back of the steel coil is covered by folding fabric 1 into the inner space, a high crease retentive material will stay in place while a worker turns to fold the fabric 1 over the front of the steel coil. The crease retention fabric will also stay in place while the securing method is added.

In contrast, low crease retention fabric does not stay in place. When the back covering fabric is folded in, low crease retention fabric pulls away from the steel coil. This requires additional adhesives to be used, or in the alternate, two workers to perform the task a single worker using high crease retention fabric can perform. Low crease retention fabric has not been well received by customers, primarily due to this pulling away.

For the reasons given above, it is seen that there is a need for a woven protective wrap that provides recylcability, VCI enhanced metal protection with the crease retention of traditional kraft paper composites.

### BRIEF SUMMARY OF THE INVENTION

The present invention provides recyclable protective wraps with crease retention in excess of 25-30% (ASTM D920-49) useful in protecting metal objects from atmospheric corrosion and moisture. The protective wraps comprise an outer barrier layer, a flexible woven substrate and an inner barrier layer. All layers are preferably of polypropylene. The outer barrier layer may further comprise ultraviolet light inhibitors. The woven substrate is preferably a tight weave. The inner barrier layer may further comprise vapor phase corrosion inhibitors. When so present, the VCIs containing inner barrier layer is preferably identified by the addition of a pigment of different color or shade than that of the outer barrier layer.

Improved crease retention is achieved by use of a flexible woven substrate having a higher secant modulus (as measured by test described in ASTM D-882). As a result, various embodiments of the present invention preferably use homopolymer polypropylene for the flexible woven substrate.

### BRIEF DESCRIPTION OF THE DRAWINGS

FIG. 1 illustrates a side sectional view of a preferred embodiment of the protective wrap according to the present invention;

FIG. 2 illustrates a plan view of a preferred embodiment of the protective wrap according to the present invention;

FIG. 3 illustrates a steel coil typical of those produced in a continuous casting steel making process;

FIGS. 4a through 4d illustrate applying a protective material to a steel coil; and

FIG. 5 illustrates high crease retention material as opposed to low crease retention material.

### DETAILED DESCRIPTION OF THE INVENTION

As used herein “crease retention” refers to the property of materials such as kraft paper to assume a stable set upon being folded and is measured by ASTM test method D920-49. This is contrasted to materials that do not achieve a stable set but rather relax to a pre-folded condition (i.e. low crease retention values). As used herein, “improved crease retention” indicates crease retention in excess of 25-30% as measured by ASTM D920-49.

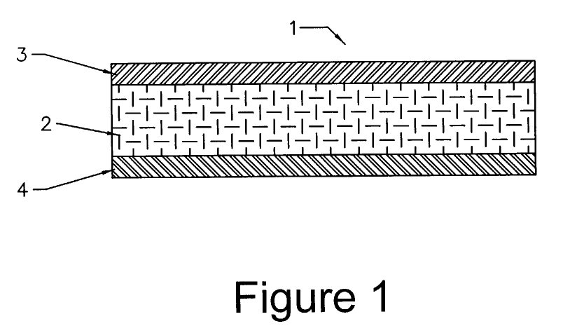

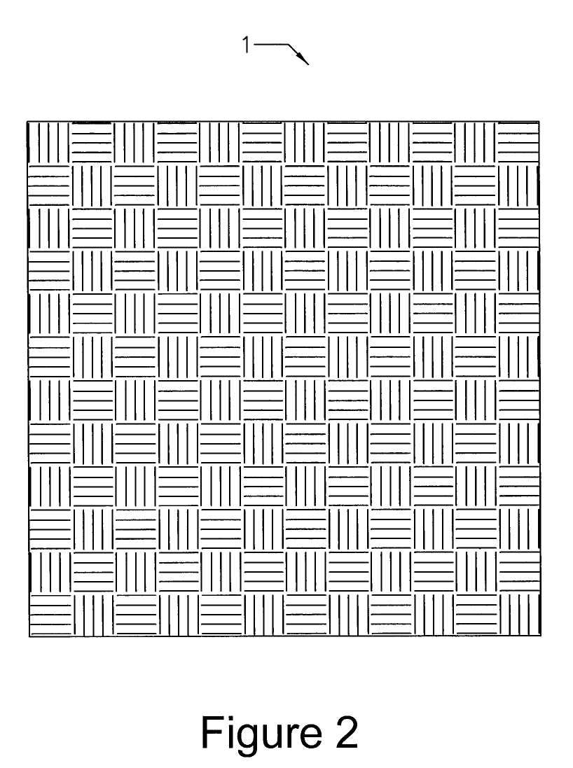

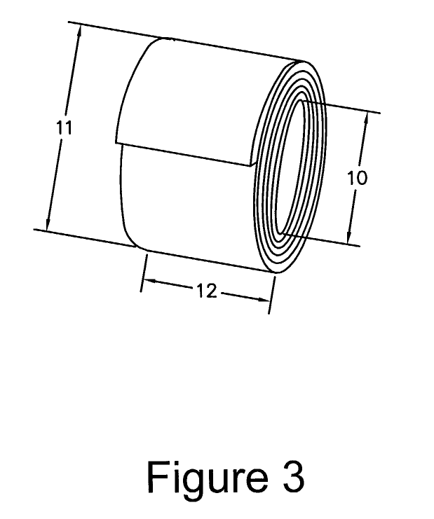

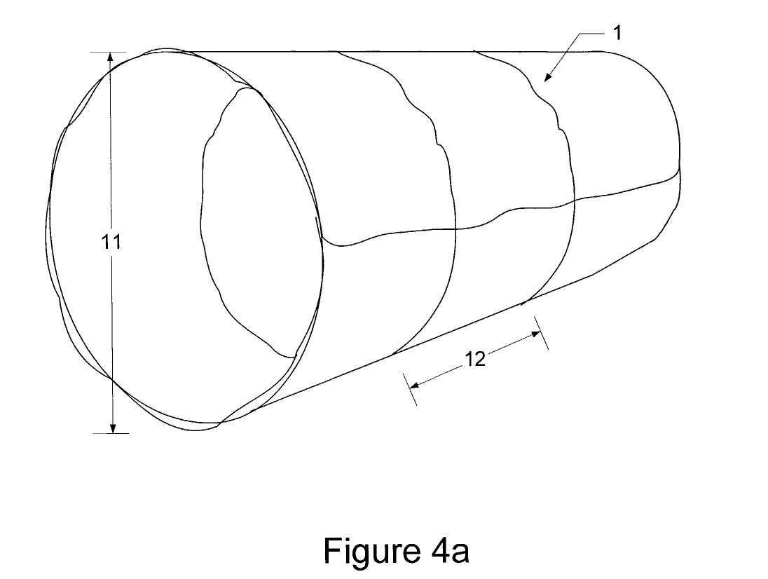

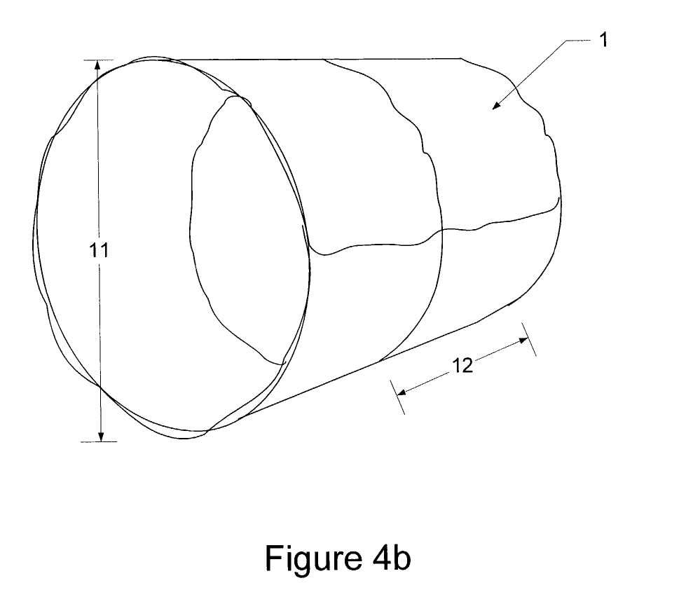

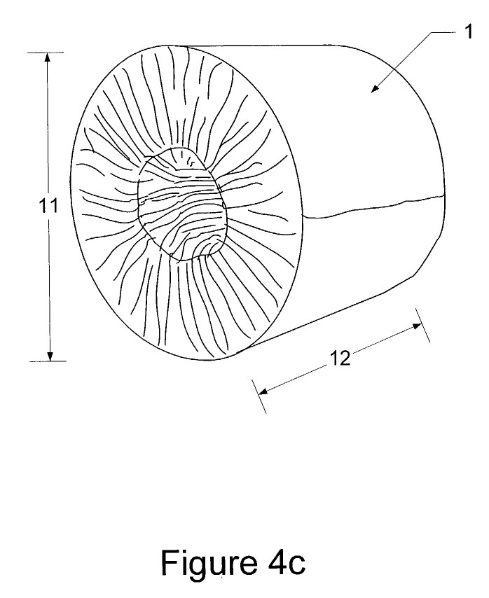

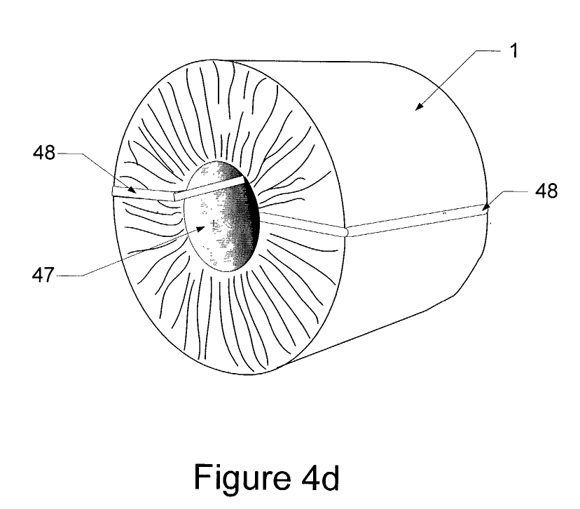

The protective wraps according to the present invention are illustrated is shown in the drawings and noted generally by the reference numeral 1. FIG. 1 illustrate a preferred embodiment of protective wrap 1 comprising a high strength, tear resistant and flexible woven substrate 2 which is bordered on its upper surface by an outer barrier layer 3 and on its lower surface by an inner barrier layer 4.

The woven substrate 2 provides a strong and flexible substrate or base that in effect carries the outer barrier layer 3 and inner barrier layer 4. The flexibility of woven substrate 2, and hence protective wrap 1, enables the material to be rolled or folded for convenience of use and storage, and also allows it to be readily wrapped around items of varying shape and size.

Although a number of different polyolefin materials could be used in the protective wraps of the present invention, it has surprisingly been found that polypropylenes combine the desired strength and chemical resistance with the crease retention desired.

Polypropylene is available as a homopolymer, random copolymer, impact copolymer or block copolymer. The flexible substrate 2 of this invention and the coatings 3 and 4 are made from homopolymer. They could also be made from impact copolymer or block copolymer. Also, a random copolymer with sufficient modulus could also be used.

The flexible woven substrate may also provide for additional tear strength by being woven of two tapes, superimposed one upon the other. The multiple superimposed tapes can be provided in either the warp or weft direction, but preferably in both directions. For example, when 2 superimposed tapes are woven in both directions, the flexible woven substrate is known as a double weave scrim or a 2×2 weave scrim.

It will be appreciated that in order for protective wrap 1 to be useful for a wide variety of different applications it must not only be strong and flexible but must also exhibit high resistance to tearing, must be abrasion resistant, must be relatively light in weight, and must be sufficiently low in cost. Furthermore, it is desired that the protective wraps be recyclable in order to reduce waste and the amount of material that must be shipped to landfill sites. In many cases, business must pay for waste disposal and therefore any reduction in non-recyclable waste can result in cost savings. It is therefore desirable, and in some cases required by users, that protective wrap 1 is recyclable.

For the above reasons, in the preferred embodiment woven substrate 2 is comprised of woven polyolefin, and more preferably polypropylene. For example, homopolymer polypropylene oriented tapes.

Within the woven material individual fibers are arranged in an approximately 90 degree grid thereby providing both an increased level of overall strength and superior tear resistance. The woven polyolefin substrate also serves as a “backbone” or weight bearing layer for protective wrap 1. Woven substrate 2 provides for a flexible and light weight product that can be readily used to wrap practically any shaped item. Woven polyolefin substrate 2 is also easily recyclable and does not present the disposal problems that are common with traditional vapor phase corrosion inhibitor products that are made from kraft paper that has been reinforced with a polyolefin film. Recylcability may be further enhanced by using only similar polyolefins throughout the protective wrap (for example, all polypropylene or all polyethylene).

In order to improve appearance of the woven polyolefin substrate, as well as improve its barrier and protective properties, the weave of the substrate is preferably a tight weave. For example, a preferred embodiment of the present invention uses a woven substrate of 11 tapes/inch in the warp direction of 900 denier polypropylene and 6 tapes/inch in the weft direction of 1200 denier polypropylene.

Covering the upper surface of woven substrate 2 is outer barrier layer 3. Outer barrier layer 3 provides a relatively impermeable layer that significantly reduces or eliminates the transmission of water, water vapor, oxygen, carbon dioxide, nitrogen dioxide and other atmospheric gases or elements. By preventing the transmission of such gases or elements through protective wrap 1, outer barrier layer 3 helps to reduce or eliminate corrosive or corrosion inducing compounds and gases from coming into contact with the metallic item wrapped in protective wrap 1.

Outer barrier layer 3 also helps to create a relatively impermeable membrane surrounding the wrapped item in order to limit the escape of vapor phase corrosion inhibitor from between protective wrap 1 and the wrapped item. Typical thickness for this layer is from about 0.0005 inch to 0.003 inches. For most uses a thickness of 0.0008 to 0.002 inches is adequate.

Additionally, the outer barrier layer 3 may further comprise compounds that prevent actinic radiation or ultraviolet (UV) light damage and degradation to the protective wrap. Useful compounds for this purpose include ultraviolet light absorbers and stabilizers. U.S. Pat. No. 6,242,597 to Gupta et al, and incorporated herein by reference discusses such compounds.

Additional compounds may be added to the outer barrier and include pigments, and heat stabilizers.

To ensure a high integrity bond between outer barrier layer 3 and woven substrate 2, and to facilitate in the recycling of protective wrap 1, outer barrier layer 3 is also comprised of polyolefin, and preferably polypropylene or polyethylene. Preferably this layer comprises polypropylene when used with polypropylene substrates and polyethylene with polyethylene substrates. This polyolefin layer has been found to also provide a tough and abrasion resistant exterior surface that can stand up to the abuse to which it will be subjected when used to wrap metallic parts, machinery or other materials during transportation or storage. In addition, outer barrier layer 3 presents a surface onto which packaging information, labeling or advertising can be readily printed. In some preferred embodiments the outer barrier layer 3 comprises a homopolymer polypropylene barrier layer having a specific gravity of approximately 0.90 to 0.94 with a thickness of 0.0008 to 0.002 inches.

In the preferred embodiment inner barrier layer 4 is bonded to the under side of woven substrate 2. Inner barrier layer 4 is impregnated with a vapor phase corrosion inhibitor that is preferably within a ratio of from about 0.5 to 10 percent by weight of the layer. A concentration of solid form vapor phase corrosion inhibitor within the above range has been found to produce a sufficiently high level of inhibitor vapor for an appropriate length of time to provide for extended and reliable corrosion protection for metallic items that are wrapped in protective wrap 1. When the inhibitor is present below 0.5 percent, limited corrosion protection is provided. When present in amounts over 10%, processing difficulties are encountered in preparing the inner barrier layer.

The approximate rate of vapor release from the VCIs can be determined so that with a known volatilization rate, and for a given concentration of inhibitor, the useful life of protective wrap 1 can be determined. Depending upon ambient conditions, the above structure may provide reliable protection for a period of from approximately 6 months to 2 years.

Preferably the inner barrier layer comprises polypropylene when used with polypropylene substrates and polyethylene with polyethylene substrates. By matching the substrate material, good adhesion and recylcability is ensured.

The precise chemical composition of the vapor phase corrosion inhibitor impregnated into inner barrier layer 4 may vary as there are a number of commercially available products that can be readily used. Particularly useful are VCIs that do not contain nitrite compounds, for example formulations comprising amine benzoates, amine nitrates or benzotriazole. Such compositions are commercially available from Cortec Corporation, Cromwell Phoenix, Northern Technologies Incorporated and Zerust Corporation.

In the preferred embodiment inner barrier layer 4 is also comprised of a polyolefin material and has a specific gravity of approximately 0.90 to 0.93. Typical thickness for this layer is from about 0.0005 inch to 0.003 inches. For most uses a thickness of 0.0008 to 0.002 inches is adequate.

Forming layer 4 from a polyolefin product ensures that all three layers of protective wrap 1 are completely recyclable and that material 1 can be readily melted and re-pelletized for re-use. This provides a significant advantage over the traditional prior art products that utilize a combination of cellulose and plastic which is not readily recyclable. Furthermore, the fact that each of inner barrier layer 4, outer barrier layer 3, and woven substrate 2 are formed from a polyolefin allows for an enhanced level of bonding between the respective layers without the addition of adhesives or complex or costly mechanical bonding steps or procedures.

Even more preferred is the use of polypropylene polyolefin. It has been surprisingly found that the use of polypropylene allows the protective wrap to have significant crease retention, thereby competing with the use characteristics of kraft paper/film composite products. Also the polypropylene materials resist hydrocarbon oils that are often present on metal parts to be protected.

Other usable polyolefins include high density polyethylene (HDPE). Although HDPE has similar properties, grades of HDPE tested to date do not provide equal crease retention. The polypropylene polyolefin produces a stiffer, easier to crease product.

Mixtures of polypropylene and polyethylene are also useful for the inner and outer barrier layers. During extrusion of a barrier layer of polypropylene, processability problems arise associated with the melt. For example, polypropylene may have insufficient melt strength with resultant neck-in and pin holing during extrusion coating of the flexible substrate. To reduce such processability challenges, some preferred embodiments of the present invention use a mixture of polypropylene and polyethylene for the barrier layers. Particularly preferred for this purpose is low density polyethylene (LDPE). Such LDPE is available commercially from a number of sources, including Nova Chemicals of Pittsburgh, Pa. Examples of suitable LDPEs are those having a melt index of from 1.0 to 20.0. Preferred mixtures for a barrier layer have a ratio of LDPE to polypropylene of from 1:8 to 1:2.

In preferred embodiments, outer barrier layer 3 and inner barrier layer 4 are extrusion coated onto woven substrate 2 thereby forming a strong bond between the respective layers. Alternately the respective layers may be extruded sequentially and heat sealed or laminated together.

Protective wraps of the present invention may comprise VCIs in the inner barrier layer 4. Preferably, when present, the VCIs are added to inner barrier layer 4 during extrusion. It has been found that the preferable method of achieving this result is to mix the VCIs with inner barrier layer polyolefin resin prior to extrusion and then extrude the combined product at below normal extrusion temperatures. That is, while typically polyolefin extrusions are carried out at temperatures of approximately 285 to 310 degrees Celsius, in the preferred embodiment of the present invention the extrusion of inner barrier layer 4 is carried out at approximately 250 to 280 degrees Celsius. This below normal temperature has been found to significantly reduce the volatilization of the vapor phase corrosion inhibitor during extrusion. As a result, the formation of pockets of gaseous vapor phase corrosion inhibitor within inner barrier layer 4, atmospheric loss of inhibitor during extrusion and pin holing in the barrier layer, have been greatly reduced.

For particular shipping and storage applications, fire retardant compounds may be added to the protective wrap. As such compounds are often incompatible with chosen VCIs, they can be limited to the outer barrier layer 3 and woven substrate 2, while the VCIs are limited to the inner barrier layer 4.

As a further feature of the present invention, if desired, woven substrate 2 may be pigmented to limit the transmission of light and ultraviolet radiation through protective wrap 1. Under some circumstances the materials being encased or wrapped in protective wrap 1 may be sensitive to light or ultraviolet radiation. Accordingly, through the pigmentation of woven substrate 2 the amount of light that is allowed to pass through protective wrap 1 can be controlled, thereby reducing photo degradation of articles wrapped therein. It will be appreciated that the outer barrier layer 3 and inner barrier layer 4 may also be pigmented in addition, or as an alternative, to the pigmentation of woven substrate 2.

The use of different shades of pigmentation can also be used as a means of identifying particular types of material (for example with or without a flame retarding compound) or may be used to identify the source or type of material that is being transported or stored.

In one preferred embodiment of the present invention, an inner barrier layer 4 comprising VCIs is pigmented with either a different color or shade of pigment to provide contrast to the outer barrier layer 3. This contrast in pigment acts to identify the side of the protective wrap to be placed against the metal being protected or the “inside” of a package. For example, a darker shade may indicate the inside of protective wrap 1.

Table 1, below identifies many of the protective properties achievable with protective wraps of the present invention:

TABLE 1

| Property | Units | Direction | Values | Test Method |
|---|---|---|---|---|
| Unit Weight | ounces per | | 4.0 | |
| | square yard | | | |
| Tensile Grab | pounds force | Warp | 175.0 | ASTM D751-A |
| | | Weft | 120.0 | |
| Tear Strength | pounds force | Warp | 45.0 | ASTM D751-B |
| | | Weft | 45.0 | |
| Mullen Burst | pounds per | | 230.0 | ASTM D751 |
| | square inch | | | |

Table 2, below summarizes the layers comprising one embodiment of the present invention:

TABLE 2

| Layer | Description |
|---|---|
| Outer Barrier | 0.0015 inch thick polypropylene further comprising UV |
| Layer | inhibitor |
| Woven | 11 tapes/inch of 900 denier polypropylene fiber in the |
| Substrate | warp direction; |
| Layer | 6 tapes/inch of 1200 denier polypropylene fiber in the |
| | weft direction |
| Inner Barrier | 0.0012 inch thick polypropylene further comprising VCIs |
| Layer | |

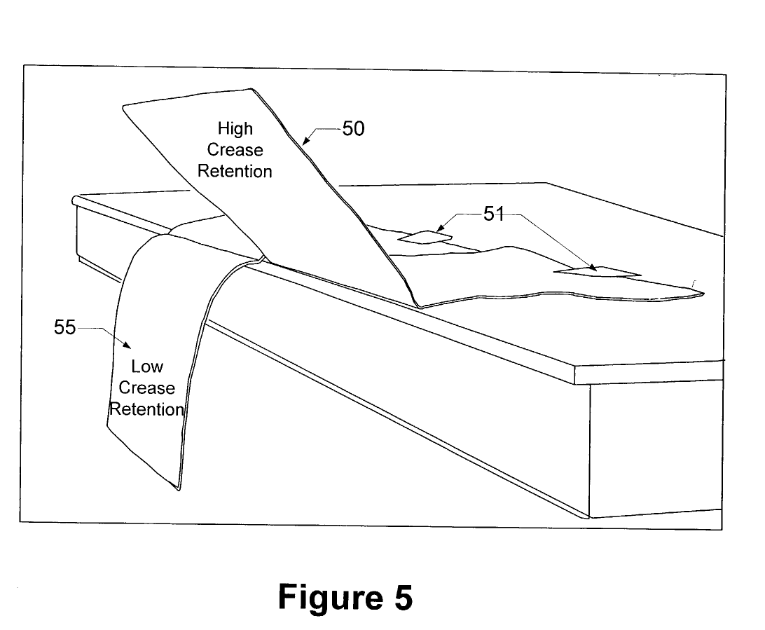

FIG. 5 illustrates how the present invention advantageously provides improved crease retention as compared to a similar protective fabric made of polyethylene substrate. A sample product 50 prepared in accordance with the present invention along with a similar compare product 55 comprising polyethylene flexible substrate were creased by rolling a 20 pound weight across the crease area 10 times. The samples were then placed in a stand and secured with an adhesive 51. The samples were next allowed to “relax” for 10 minutes. Surprisingly the protective wrap 50 prepared in accordance with the present invention had a crease retention similar to that of kraft paper. In contrast, the compare material 55 had very little crease retention.

Crease retention testing was also performed in accordance with ASTM test method 920-49, Method B. It was found that one embodiment of the present invention, as identified in Table 2, above, had a crease retention of about 30% in the weft direction and 36% in the warp direction. In comparison, a polyethylene compare fabric of equal weight had a measured crease retention of 13% in both the warp and weft directions. It is seen that the crease retention of the present invention is more than twice that of conventional polyethylene woven protective wraps.

It is to be understood that what have been described are the preferred embodiments of the invention and that it is possible to make variations to these embodiments while staying within the broad scope of the invention. Some of these variations have been discussed while others will be readily apparent to those skilled in the art. For example, while in the preferred embodiment woven substrate 2 has been described as a woven material, it could also be comprised of a knit, a non-woven, a tri-axial weave or a stitchbond material having sufficient strength for the particular application for which it is to be used. In addition the vapor phase corrosion inhibitor may be prepared as a solid and co-extruded with the inner barrier layer, or in the alternative be prepared as a liquid and separately applied to the exposed surface of the inner barrier layer.

What is claimed is:

1. A recyclable protective wrap with improved crease retention comprising:
(ii) an outer barrier layer;
(ii) a flexible woven substrate; and
(iii) an inner barrier layer, said inner barrier layer impregnated with a solid form vapor phase corrosion inhibitor of from about 0.5 to 10 percent by weight,
wherein the outer barrier layer, flexible woven substrate and inner barrier layer comprise a polyolefin material and together form a protective wrap with improved crease retention.

2. The protective wrap of claim [c1] wherein the polyolefin materials are selected from the group consisting of polypropylene homopolymer, polypropylene random copolymer, polypropylene impact copolymer, polypropylene block copolymer and low density polyethylene.

3. The protective wrap of claim [c1] wherein the crease retention as determined by ASTM 920-49 exceeds 13%.

4. The protective wrap of claim [c1] wherein the crease retention as determined by ASTM 920-49 exceeds 26%.

5. The protective wrap of claim [c1] wherein the outer barrier layer and the inner barrier are of different colors.

6. The protective wrap of claim [c1] wherein the outer barrier layer and the inner barrier are of different shades.

7. The protective wrap of claim [c1] wherein the flexible woven substrate further comprises 2 or more superimposed tapes in the warp direction.

8. The protective wrap of claim [c1] wherein the flexible woven substrate further comprises 2 or more superimposed tapes in the weft direction.

9. The protective wrap of claim [c1] wherein the flexible woven substrate further comprises a double weave scrim.

10. The protective wrap of claim [c2] wherein the flexible woven substrate comprises 11 tapes/inch in the warp direction of 900 denier polypropylene yarn and 6 tapes/inch in the weft direction of 1200 denier polypropylene yarn.

11. The protective wrap of claim [c2] wherein the outer barrier layer comprises a layer of from 0.0005 to 0.003 inch thickness of a polypropylene further comprising ultraviolet light inhibitors.

12. The protective wrap of claim [c2] wherein the outer barrier layer comprises a layer of from 0.0008 to 0.002 inch thickness of a polypropylene further comprising ultraviolet light inhibitors.

13. The protective wrap of claim [c2] wherein the inner barrier layer comprises a layer of from 0.0005 to 0.003 inch thickness of a polypropylene.

14. The protective wrap of claim [c2] wherein the inner barrier layer comprises a layer of from 0.0008 to 0.002 inch thickness of a polypropylene.

15. A recyclable protective wrap with improved crease retention comprising:
(ii) an outer barrier layer;
(ii) a flexible polypropylene woven substrate; and
(iii) an inner barrier layer, said inner barrier layer impregnated with a solid form vapor phase corrosion inhibitor of from about 0.5 to 10 percent by weight,
wherein the flexible polypropylene woven substrate comprises polypropylene materials selected from the group consisting of polypropylene homopolymer, polypropylene random copolymer, polypropylene impact copolymer, and polypropylene block copolymer,
wherein the inner barrier layer and outer barrier layer comprise polyolefin materials selected from the group consisting of polypropylene and polyethylene, and
wherein the flexible polypropylene woven substrate, inner barrier layer and outer barrier layer form a protective wrap with improved crease retention.

16. The protective wrap of claim [c15] wherein the outer barrier layer comprises a layer of from 0.0005 to 0.003 inch thickness of a polypropylene further comprising ultraviolet light inhibitors.

17. The protective wrap of claim [c15] wherein the outer barrier layer comprises a layer of from 0.0008 to 0.002 inch thickness of a polypropylene further comprising ultraviolet light inhibitors.

18. The protective wrap of claim [c15] wherein the inner barrier layer comprises a layer of from 0.0005 to 0.003 inch thickness of a polypropylene.

19. The protective wrap of claim [c15] wherein the inner barrier layer comprises a layer of from 0.0008 to 0.002 inch thickness of a polypropylene.

20. The protective wrap of claim [c15] wherein the inner barrier layer and outer barrier layer comprise a mixture of polyethylene and polypropylene wherein the ratio of the amount of polyethylene to the amount of polypropylene in the layer is from 1:2 to 1:8.
